(19) United States
(12) Patent Application Publication
(10) Pub. No.: US 2013/0249824 A1
(43) Pub. Date: Sep. 26, 2013

(54) Display Device

(71) Applicant: VOLKSWAGEN AG, Wolfsburg (DE)

(72) Inventors: Klaus Schaaf, Braunschweig (DE); Arne Stoschek, Palo Alto, CA (US); Brian Michael Finn, East Palo Alto, CA (US); Michael Prados, Millbrae, CA (US)

(73) Assignee: VOLKSWAGEN AG, Wolfsburg (DE)

(21) Appl. No.: 13/728,202

(22) Filed: Dec. 27, 2012

Related U.S. Application Data
(63) Continuation of application No. 10/942,715, filed on Sep. 16, 2004, now abandoned.

(51) Int. Cl. G06F 3/041

(52) U.S. Cl. CPC G06F 3/0416
USPC 345/173

(57) ABSTRACT

A display device includes touch screen for the visual display of information and for the input of command and an actuator for moving the touch screen in a direction substantially perpendicular to the touch screen. The touch screen is movable by the actuator by more than 2 mm in the direction substantially perpendicular to the touch screen.

### CROSS-REFERENCE TO RELATED APPLICATIONS

The present application claims the benefit of U.S. Provisional Application Ser. No. 60/503,188, filed on Sep. 16, 2003, which is expressly incorporated herein in its entirety by reference thereto.

### FIELD OF THE INVENTION

The present invention relates to a display device, e.g., for a motor vehicle, having a touch screen for the visual display of information and for the input of commands, and having an actuator for moving the touch screen in a direction essentially perpendicular to the touch screen. The present invention also relates to a navigation system, e.g., a navigation system for a motor vehicle.

### BACKGROUND INFORMATION

A touch screen is described, for example, in German Published Utility Model No. 201 02 197, which is expressly incorporated herein in its entirety by reference thereto. German Published Utility Model No. 201 02 197 describes a touch screen for visually representing electronic signals and for inputting characters and symbols by touching the screen for confirmation purposes. It includes a functional plane for visual representation and touch input and a higher-situated protective plane corresponding thereto that is deformable at certain points. In this context, when certain points of the functional plane are selected by touching-type contact across the protective plane, at least one confirmation signal is generated for the user's sense of touch (haptic stimulus) that is perceptible at the position of the point of contact in the deformed protective plane, and the confirmation signal for the sense of touch (haptic stimulus) is generated by vibration elements eccentrically positioned within and/or underneath the functional plane. In addition, in the touch screen described in German Published Utility Model No. 201 02 197, the generated vibrations are transmitted from the functional plane to the protective plane as the result of direct contacting of the two planes and/or via the edge regions of the planes by rigid or elastic connecting elements.

Details concerning touch screens may be found, for example, from the Internet page www.3m.com/3mtouchsystems. For example, the following touch screens are believed to be offered by 3M™:

MicroTouch™ 12.1″ FPD Touch Monitor (see, www.3m.com/3mtouchsystems/Products/Monitors/FPDdesktop.jhtml);

MicroTouch™ M150 FPD Touch Monitor (see, www.3m.com/3mtouchsystems/Products/Monitors/M150.jhtml);

MicroTouch™ CRT Touch Monitors (see, www.3m.com/3mtouchsystems/Products/Monitors/CRTdesktop.jhtml);

MicroTouch™ ChassisTouch™ FPD Touch Monitors (see, www.3m.com/3mtouchsystems/Products/Monitors/FPDchassis.jhtml); and

MicroTouch™ ChassisTouch™ CRT Touch Monitor (see, www.3m.com/3mtouchsystems/Products/Monitors/CRTchassis.jhtml).

Further particulars concerning touch screens may be found from the following Internet pages:

www.elotouch.com/products/default.asp;

www.3m.com/3mtouchsystems/Products/Resistive/5-wire.jhtm;

www.3m.com/3mtouchsystems/Products/Resistive/PL.jhtml;

www.3m.com/3mtouchsystems/Products/Resistive/FG.jhtml; and

www.3m.com/3mtouchsystems/Products/Resistive/SRTS.jhtml.

In German Published Utility Model No. 201 80 024 and PCT International Published Patent Application No. WO 01/54109, which is expressly incorporated herein in its entirety by reference thereto, a touch-sensitive control featuring haptic feedback for inputting signals into a computer and for outputting forces to a user of the touch-sensitive control is described, the touch-sensitive control having a touch-screen input device which has a virtually planar touch-screen surface. On the basis of a position on the touch-screen surface that is touched by a user, a positional signal is input into a processor of the computer, the positional signal reproducing the position in two dimensions. The touch-sensitive control described in PCT International Published Patent Application No. WO 01/54109 also has at least one actuator connected to the touch-screen input device, the actuator outputting a force to the touch-screen input device to provide the user touching the touch-screen surface with a haptic sensation, the actuator outputting the force directly to the touch-screen input device on the basis of force information output by the processor.

Haptic feedback is also described in U.S. Pat. No. 6,429,846 and PCT International Published Patent Application No. WO 03/041046, each of which is expressly incorporated herein in its entirety by reference thereto.

In German Published Patent Application No. 197 31 285, an operating element for a device having a plurality of selectable menus, functions and/or functional values is described. Its operating surface is understandable to the user and, by locally moving or touching the operating surface, the user is able to make his/her selection. The form of the operating surface can be altered to conform with the selected and/or selectable menu, function and/or functional value.

### SUMMARY

According to an example embodiment of the present invention, a display device and a navigation system having a touch screen may be provided.

According to an example embodiment of the present invention, a display device, e.g., for a motor vehicle, includes a touch screen for the visual display of information relevant, e.g., for the operation of a motor vehicle, and for the input of commands relevant, e.g., for the operation of a motor vehicle, and includes an actuator for moving the touch screen in a direction substantially perpendicular to the touch screen, the touch screen being movable by the actuator by more than 2 mm in the direction substantially perpendicular to the touch screen.

According to an example embodiment of the present invention, a display device, e.g., for a motor vehicle, includes a touch screen for the visual display of information relevant, e.g., for the operation of a motor vehicle, and for the input of commands relevant, e.g., for the operation of a motor vehicle, includes an actuator for moving the touch screen, e.g., in a direction substantially perpendicular to the touch screen, and includes a control for triggering the actuator. The control is able to trigger the actuator such that the touch screen is movable by the actuator, e.g., by at least 2 mm, in the direction substantially perpendicular to the touch screen for confirming a command input using the touch screen.

A coil such as a so-called voice coil may be provided as an actuator.

In an example embodiment of the present invention, the touch screen may be movable by the actuator by more than 3 mm, e.g., by more than 4 mm to 6 mm, in the direction substantially perpendicular to the touch screen.

In an example embodiment of the present invention, the display device may include a control for triggering the actuator, the actuator being controllable by the control such that the touch screen is movable by the actuator in the direction substantially perpendicular to the touch screen for confirming a command input using the touch screen.

In an example embodiment of the present invention, to confirm the command input using the touch screen, the touch screen may be movable for a duration between 50 ms and 800 ms, e.g., for a duration between 100 ms and 400 ms, in the direction substantially perpendicular to the touch screen.

In an example embodiment of the present invention, the touch screen may be movable periodically in the direction substantially perpendicular to the touch screen for confirming the command input using the touch screen.

In an example embodiment of the present invention, to confirm the command input using the touch screen, the touch screen may be movable in the direction substantially perpendicular to the touch screen with a decaying oscillation.

In an example embodiment of the present invention, the decaying oscillation may include an envelope curve having an exponential component. In this context, the envelope curve has, for example, a term to or a term b^{t}, t representing the time and a and b representing variables. Thus, the envelope curve may be a function of a1+a2*t^{a3} or b1+b2^{t}, where a1, a2, a3, b1 and b2 represent variables. It may be provided that the envelope curve includes a term t² as the highest power.

In an example embodiment of the present invention, the touch screen may be movable periodically with a frequency between 10 and 80 Hz in the direction substantially perpendicular to the touch screen to confirm the command input using the touch screen. In this case, a frequency of approximately or around 40 Hz may be provided.

In an example embodiment of the present invention, the actuator may also be controllable by the control such that the touch screen is movable in the direction substantially perpendicular to the touch screen when a user of the touch screen touches it at a spot displayable by the touch screen. The spot thus displayable may be, for example, an operating element depicted on the touch screen, a key depicted on the touch screen, a road represented on the touch screen, a settlement, small village or collection of houses represented on the touch screen, a place information represented on the touch screen, etc.

According to an example embodiment of the present invention, a navigation system, e.g., for a motor vehicle, includes a touch screen for the visual display of a geographical map or road map and for detecting a touching of the touch screen (by a user of the navigation system), and an actuator for moving the touch screen in a direction substantially perpendicular to the touch screen as a function of a position at which the touch screen is touched (by the user). In an example embodiment, the navigation system may include a display device having one or more of the aforesaid features.

In an example embodiment of the present invention, a road may be displayable on the touch screen. The road displayed on the touch screen, in response to touching by the user, may be recognizable for the sense of touch of the user by a movement of the touch screen.

In an example embodiment of the present invention, a settlement may be displayable on the touch screen. The settlement displayed on the touch screen, in response to touching by the user, may be recognizable for the sense of touch of the user by a movement of the touch screen.

In an example embodiment of the present invention, place information may be displayable on the touch screen. The place information displayed on the touch screen, in response to touching by the user, may be recognizable for the sense of touch of the user by a movement of the touch screen.

Further prominent landmarks may also be displayable on the touch screen. They, or a portion of these prominent landmarks displayable on the touch screen, in response to touching by the user, are recognizable for the sense of touch of the user by a movement of the touch screen.

According to an example embodiment of the present invention, in a method for operating a touch screen for the visual display of information and for the input of commands, the touch screen may be moved by more than 2 mm in a direction substantially perpendicular to the touch screen.

According to an example embodiment of the present invention, in a method for operating a touch screen for the visual display of information and for the input of commands, the touch screen may be moved in a direction substantially perpendicular to the touch screen for confirming a command input using the touch screen. In this context, in an example embodiment of the present invention, the touch screen may be moved by more than 2 mm in the direction substantially perpendicular to the touch screen.

In the aforesaid methods, the touch screen may be moved by more than 3 mm, e.g., by more than 4 mm, in the direction substantially perpendicular to the touch screen.

In the aforesaid methods, to confirm the command input using the touch screen, the touch screen may be moved for a duration between 50 ms and 800 ms, e.g., for a duration between 100 ms and 400 ms, in the direction substantially perpendicular to the touch screen.

In the aforesaid methods, the touch screen may be moved periodically in the direction substantially perpendicular to the touch screen to confirm the command input using the touch screen.

In the aforesaid methods, the touch screen may be moved periodically with a frequency between 10 and 80 Hz in the direction substantially perpendicular to the touch screen to confirm the command input using the touch screen.

In the aforesaid methods, the touch screen may be moved with a decaying oscillation in the direction substantially perpendicular to the touch screen to confirm the command input using the touch screen.

In the aforesaid methods, the touch screen may be moved in the direction substantially perpendicular to the touch screen when a user of the touch screen touches it at a spot displayable by the touch screen.

According to an example embodiment of the present invention, a method for operating a navigation system having a touch screen for the visual display of a geographical map or road map includes detection of a touching of the touch screen by a user of the navigation system at a position highlighted for accentuation on the touch screen, and a moving of the touch screen in a direction substantially perpendicular to the touch screen.

A perpendicular or vertical movement of the touch screen does not rule out that the touch screen is also movable in other directions at the same time. Therefore, a perpendicular movement of the touch screen within the context hereof may mean, e.g., that a movement has a suitable perpendicular component. However, it may be provided that the touch screen is only moved in a range of 80° to 100° if a movement in a direction substantially perpendicular to the touch screen is mentioned in the aforesaid.

A motor vehicle within the present context may be, e.g., a land vehicle that is able to be used individually in road traffic. However, motor vehicles within the present context are not limited to land vehicles having combustion engines.

Further aspects and details are set forth below in the following description of exemplary embodiments with reference to the appended Figures.

### BRIEF DESCRIPTION OF THE DRAWINGS

FIG. 1 illustrates an exemplary embodiment of a cockpit of a motor vehicle.

FIG. 2 illustrates an exemplary embodiment of a cockpit of a motor vehicle.

FIG. 3 illustrates a display device.

FIG. 4 illustrates a movement of the touch screen in a direction substantially perpendicular to the touch screen.

FIG. 5 illustrates a movement of the touch screen in a direction substantially perpendicular to the touch screen.

FIG. 6 illustrates a control signal for moving the touch screen in a direction substantially perpendicular to the touch screen.

FIG. 7 illustrates an exemplary embodiment of a mask base displayed by a display device.

FIG. 8 illustrates an exemplary embodiment of a mask for operating an air conditioner.

FIG. 9 illustrates an exemplary embodiment of a mask for operating a navigation system.

FIG. 10 illustrates an exemplary embodiment of a submask for operating a navigation system.

FIG. 11 illustrates an exemplary embodiment of a further submask for operating a navigation system.

FIG. 12 illustrates an exemplary embodiment of a mask for operating a telephone.

### DETAILED DESCRIPTION

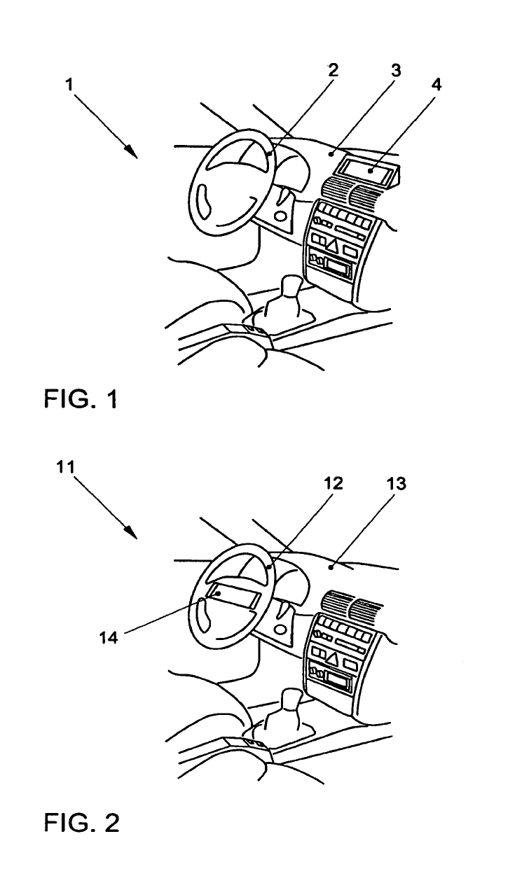

FIG. 1 illustrates an exemplary embodiment of a cockpit 1 of a motor vehicle. In cockpit 1, a steering wheel 2 is positioned below an instrument panel or dashboard 3. Instrument panel 3 has a display device 4 positioned next to steering wheel 2. FIG. 2 illustrates an exemplary embodiment of a cockpit 11 of a motor vehicle, a steering wheel 12 being positioned below an instrument panel 13 in cockpit 11. However, departing from the exemplary embodiment illustrated in FIG. 1, a display device 14 is positioned in steering wheel 12.

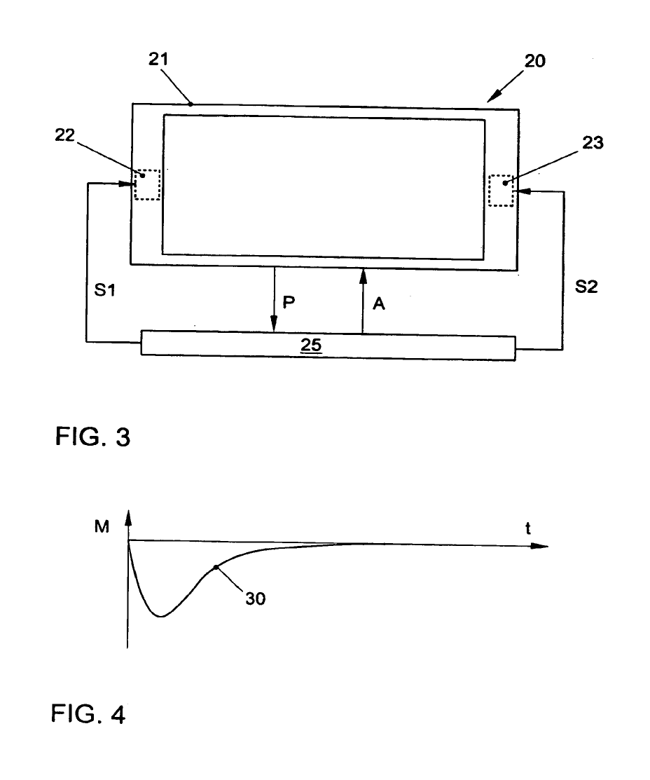

FIG. 3 illustrates—as a possible exemplary embodiment of a display device 4 or 14—a display device 20 having a touch screen 21, illustrated in plan view, for the visual display of information and for the input of commands. Touch screen 21 is connected, from the standpoint of data-systems engineering, to a control 25 from which a signal A having information to be displayed on touch screen 21 is transmitted to touch screen 21. From touch screen 21, control 25 receives a signal P that indicates where a user of touch screen 21 is touching touch screen 21 and/or—if provided—whether the user is pressing on a position, characterized as input position, on touch screen 21 such that it is to be understood as an input.

At the lateral edges of touch screen 21, display device 20 has actuators 22 and 23 for moving touch screen 21 in a direction substantially perpendicular to touch screen 21. Control 25 transmits control signals S1 and S2 to actuators 22 and 23, which trigger actuators 22 and 23 such that touch screen 21 is able to be moved by at least 2 mm, e.g., by approximately 4 mm, in the direction substantially perpendicular to touch screen 21.

It may be provided that an input is effected by simple touching of touch screen 21. However, provision may also be made that an input is not effected by simple touching of touch screen 21, but rather by, e.g., light, pressing on touch screen 21. In this case, it may be provided that touch screen 21 is moved not only for confirming a command input using touch screen 21, but also in response to touching certain positions on touch screen 21. The movements may be differentiated for a user. Thus, a deflection of touch screen 21, caused by touching a specific position on touch screen 21, may last as long as the touching of this or another position leading to a comparable deflection persists. On the other hand, a short-duration deflection may take place as confirmation of the input of a command, as is explained in the following with reference to FIGS. 4 to 6.

FIG. 4 illustrates an exemplary embodiment of a movement 30 of touch screen 21 as confirmation of an input using touch screen 21, represented over time t. M designates the deflection of touch screen 21 in a direction perpendicular to touch screen 21. In this context, the deflection of touch screen 21 may take place for a duration between 50 ms and 800 ms, e.g., for a duration between 100 ms and 400 ms.

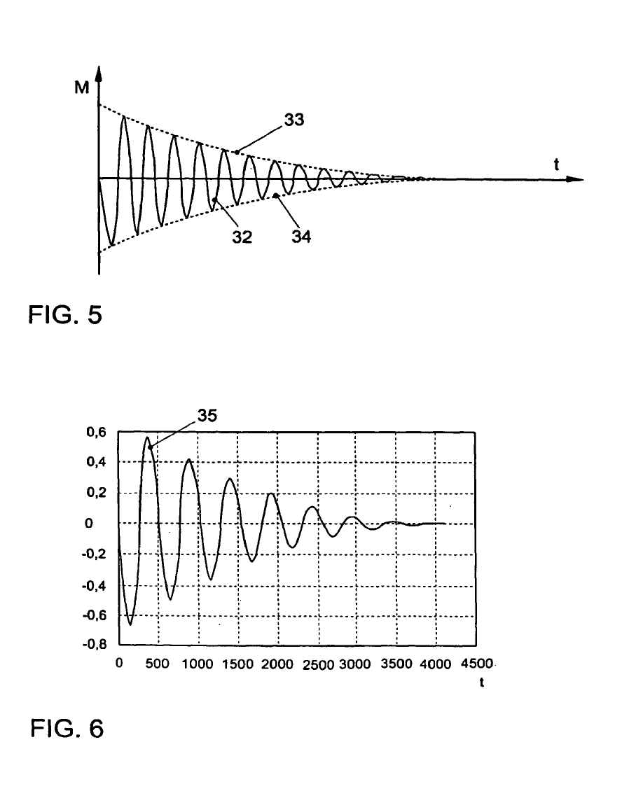

In an example embodiment, to confirm the command input using the touch screen—as illustrated in FIG. 5 as deflection M of touch screen 21 over time t—touch screen 21 is movable with a decaying oscillation 32 in the direction perpendicular to touch screen 21. Decaying oscillation 32 has an envelope curve 33 and 34, respectively, having an exponential component. In this context, envelope curve 33 and 34 has, for example, a term to or a term b^{t}, where a and b represent variables. Thus, envelope curve 33 and 34 may be a function of a1+a2*t^{a3} or b1+b2^{t}, where a1, a2, a3, b1 and b2 represent variables. It may be provided that envelope curve 33 and 34 includes a term t² as the highest power.

In addition, decaying oscillation 32 has a frequency between 10 and 80 Hz. A frequency of approximately or around 40 Hz may be provided.

FIG. 6 illustrates a control signal 35 for moving touch screen 21 in a direction substantially perpendicular to touch screen 21 over time t in sampling points, one sampling interval being 51.2 μs. Control signal 35 is illustrated normalized to its maximum value. It has a frequency of 38.1 Hz, and has decayed after 210 ms, the decay taking place according to a quadratic relation.

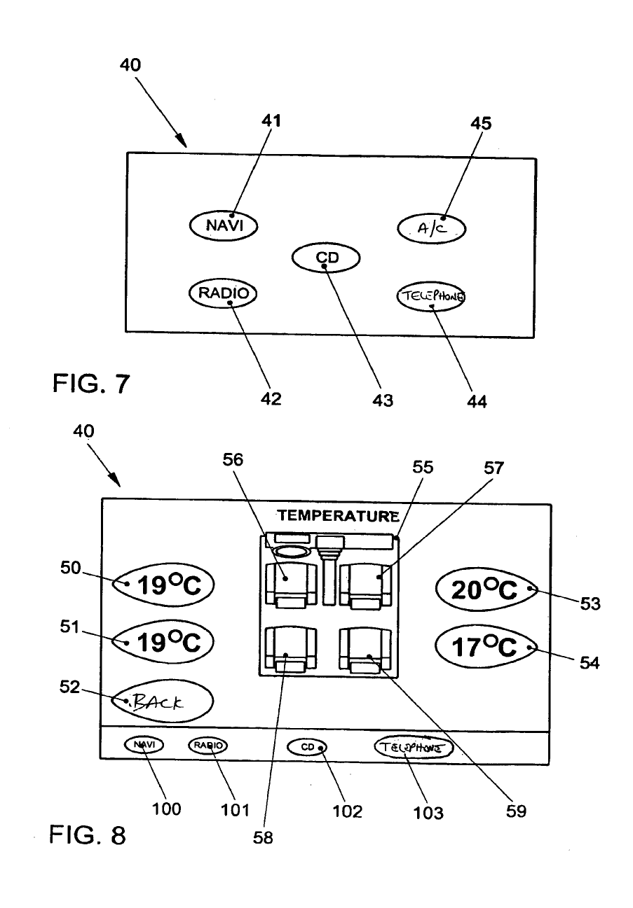

Display devices 4 and 14, built in accordance with display device 20, may replace a display and operating device described in PCT International Published Patent Application No. WO 00/21795, which is expressly incorporated herein in its entirety by reference thereto, retaining its menu-driven functionality. FIGS. 7 to 12 illustrate masks which are displayable by a display device 40.

In this context, display device 40 is built in accordance with display device 20.

FIG. 7 illustrates display device 40 having a mask base. Display device 40 displays five operating elements 41, 42, 43, 44 and 45 arranged as ellipses. By touching or pressing operating element 42 in FIG. 7, a mask for operating a radio is called up, and by touching or pressing operating element 43 in FIG. 7, a mask for operating a CD player is called up.

By touching or pressing operating element 45 in FIG. 7, a mask, illustrated in FIG. 8, for operating an air conditioner is called up. In the mask illustrated in FIG. 8, temperature information about the individual locations in the passenger compartment together with operating elements 50, 51, 52, 53 and 54 are displayed, the temperature information relating to currently set temperatures which may be changed via operating elements 50, 51, 53 and 54.

The representation illustrated in FIG. 8 having the title “temperature” and the display of a passenger compartment 55 of a motor vehicle makes clear that the temperature setting in the passenger compartment is adjustable individually and specific to the seat. Operating element 50 indicates that a temperature of 19° C. is set for front driver's seat 56. Operating element 53 indicates that a temperature of 20° C. is set for front passenger's seat 57. For rear seats 58 and 59, 19° C. is set on the left side and 17° C. is set on the right side. Operating element 52 has an assignment, i.e., a function assignment, which is represented in the display field by “Back”.

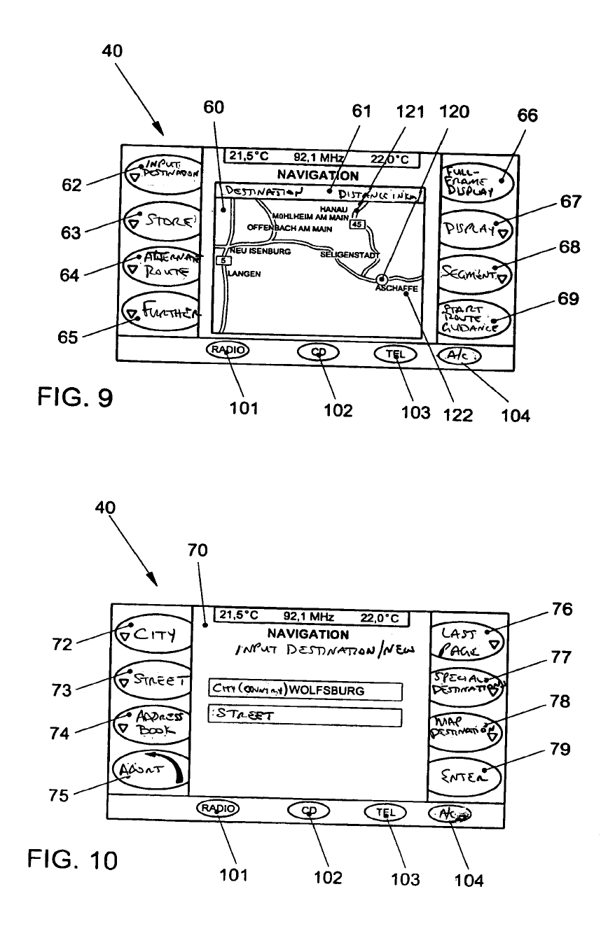

By touching or pressing operating element 41 in FIG. 7, a mask, illustrated in FIG. 9, for operating a navigation system is called up. The mask illustrates a segment of road map 60 of the instantaneous vehicle location, as well as, above road map 60 in a field 61, the destination and the distance to the destination. Operating elements 62, 63, 64, 65, 67 and 68 are also displayed, by which, through touching or pressing, submasks may be called up. In addition, an operating element 66 is represented for depicting a full-frame display, and an operating element 69 is represented for starting a guidance system. Reference is made to PCT International Published Patent Application No. WO 00/21795, which is expressly incorporated herein in its entirety by reference thereto, with respect to details concerning the underlaid menu, operating elements 62, 63, 64, 65, 66, 67, 68 and 69 replacing operating elements 3a, 3b, 3c, 3d, 3e, 3f, 3g and 3h described in PCT International Published Patent Application No. WO 00/21795.

By touching or pressing operating element 62 in FIG. 9, a submask as illustrated in FIG. 10 is called up which displays the journey destination in a field 70. In addition, operating elements 72, 73, 74, 75, 76, 77, 78 and 79 are displayed by the submask as illustrated in FIG. 10. Reference is made to PCT International Published Patent Application No. WO 00/21795 with respect to details concerning the underlaid menu, operating elements 72, 73, 74, 75, 76, 77, 78 and 79 depicted on the display replacing operating elements 3a, 3b, 3c, 3d, 3e, 3f, 3g and 3h described in PCT International Published Patent Application No. WO 00/21795.

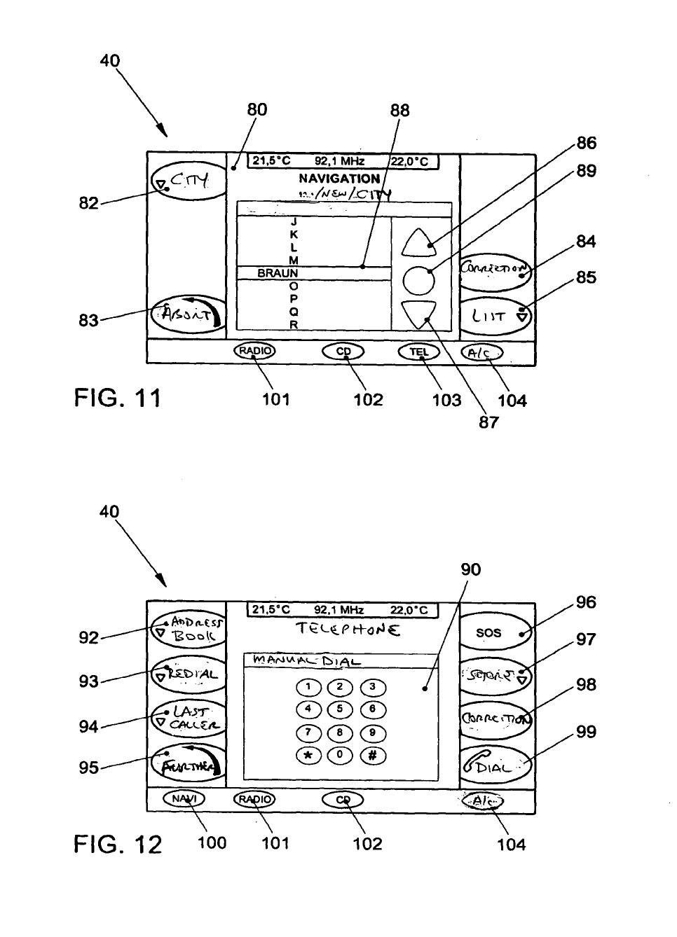

By touching or pressing operating element 72 in FIG. 10, a submask as illustrated in FIG. 11 is called up which, in a field 80, displays a destination to be input. Also displayed by the submask as illustrated in FIG. 11 are operating elements 82, 83, 84 and 85 which replace operating elements 3a, 3d, 3g and 3h described in PCT International Published Patent Application No. WO 00/21795. An alphabetical-letter selection line 88, as well as operating elements 86, 87 and 89 are represented in field 80. Alphabetical-letter selection line 88 is movable up or down by touching or pressing operating elements 86 and 87, respectively. A highlighted alphabetical letter may be selected by touching or pressing operating element 89.

By touching or pressing operating element 44 in FIG. 7, a mask, illustrated in FIG. 12, for operating a telephone is called up which, in a field 90, displays selector buttons for a telephone. Also displayed by the submask as illustrated in FIG. 12 are operating elements 92, 93, 94, 95, 96, 97, 98 and 99 which replace operating elements 3a, 3b, 3c, 3d, 3e, 3f, 3g and 3h described in PCT International Published Patent Application No. WO 00/21795. The selector buttons, displayed in field 90, for a telephone are arranged as operating elements by which a telephone number may be dialed.

Also shown in the masks and submasks illustrated in FIGS. 7 to 12, respectively, are operating elements 100, 101, 102, 103 and 104 which correspond to operating elements 41, 42, 43, 44 and 45.

A haptic feedback is produced with the aid of operating elements 41, 42, 43, 44, 45, 50, 51, 52, 53, 54, 62, 63, 64, 65, 66, 67, 68, 69, 72, 73, 74, 75, 76, 77, 78, 79, 82, 83, 84, 85, 86, 87, 89, 92, 93, 94, 95, 96, 97, 98, 99, 100, 101, 102, 103 and 104. To that end, the touch screen of display 40 is moved in a manner described with reference to FIGS. 4 to 6 when, by touching or pressing suitable operating element 41, 42, 43, 44, 45, 50, 51, 52, 53, 54, 62, 63, 64, 65, 66, 67, 68, 69, 72, 73, 74, 75, 76, 77, 78, 79, 82, 83, 84, 85, 86, 87, 89, 92, 93, 94, 95, 96, 97, 98, 99, 101, 102, 103, 104 and 105, respectively, a user input is implemented, i.e., when the touching, for example, is performed long enough and/or sufficient pressure has been exerted on the touch screen. This may be provided for use in a motor vehicle, since an operator, thus, for example, the driver of a motor vehicle, in this manner receives a confirmation of his/her input without having to look at the display. Safety while driving may thereby be increased.

It may be provided that the touch screen is moved in the direction of a user when operating element 41, 42, 43, 44, 45, 50, 51, 52, 53, 54, 62, 63, 64, 65, 66, 67, 68, 69, 72, 73, 74, 75, 76, 77, 78, 79, 82, 83, 84, 85, 86, 87, 89, 92, 93, 94, 95, 96, 97, 98, 99, 101, 102, 103, 104 or 105 is touched, so that the feeling of a three-dimensional operating element ensues for the user. It may further be provided that the touching of suitable operating element 41, 42, 43, 44, 45, 50, 51, 52, 53, 54, 62, 63, 64, 65, 66, 67, 68, 69, 72, 73, 74, 75, 76, 77, 78, 79, 82, 83, 84, 85, 86, 87, 89, 92, 93, 94, 95, 96, 97, 98, 99, 101, 102, 103, 104 or 105 is only interpreted as a user input after a brief time span has elapsed. In this case, the touch screen of display 40 is moved in a manner described with reference to FIGS. 4 to 6.

A haptic feedback may be provided with regard to road map 60 in field 61 in FIG. 9. Thus, for example, the touch screen may be moved in the direction of a user when a settlement 120, a road 121 or place information 122 is touched, so that the feeling of a three-dimensional contour of road map 60 ensues for the user. In addition, it may be provided that a destination is input by touching place information 122 on road map 60. In this context, a successful selection may result for the user by a haptic feedback described with reference to FIGS. 4 to 6.

The device may also be transferable to a multifunctional operating device as described in German Published Patent Application No. 101 39 693, which is expressly incorporated herein in its entirety by reference thereto. For example, the rotating element described in German Published Patent Application No. 101 39 693 may be replaced by operating elements arranged according to operating elements 86 and 87.

REFERENCE NUMERAL LIST

| | |
|---|---|
| 1, 11 | cockpit |
| 2, 12 | steering wheel |
| 3, 13 | instrument panel |
| 4, 14, 20, 40 | display device |
| 21 | touch screen |
| 22, 23 | actuator |
| 25 | control |
| 30 | movement |
| 32 | oscillation |
| 33, 34 | envelope curve |
| 35 | control signal |
| 41, 42, 43, 44, 45, | operating elements |
| 50, 51, 52, 53, 54, | |
| 62, 63, 64, 65, 66, | |
| 67, 68, 69, 72, 73, | |
| 74, 75, 76, 77, 78, | |
| 79, 82, 83, 84, 85, | |
| 86, 87, 89, 92, 93, | |
| 94, 95, 96, 97, 98, | |
| 99, 100, 101, 102, | |
| 103, 104 | |
| 55 | passenger compartment |
| 56 | driver's seat |
| 57 | front passenger seat |
| 58, 59 | rear seat |
| 60 | road map |
| 61, 70, 80, 90 | field |
| 88 | alphabetical-letter selection line |
| 120 | settlement |
| 121 | road |
| 122 | place information |
| A, P | signal |
| a, a1, a2, a3, | variable |
| b, b1, b2 | |
| S1, S2 | control signals |
| t | time |

1. A display device, comprising:
a touch screen configured to visually display information and to input commands; and
an actuator configured to move the touch screen in a direction substantially perpendicular to the touch screen, the touch screen movable by the actuator by more than 2 mm in the direction substantially perpendicular to the touch screen;
wherein the display device is in a motor vehicle; and
wherein the touch screen and the actuator are configured for use during driving operation of the motor vehicle, and the touch screen is movable by the actuator by more than 2 mm such that movement of the touch screen is detectable by a vehicle occupant during the driving operation of the motor vehicle.

2. The display device according to claim 1, wherein actuator is configured to move the touch screen by more than one of (a) 3 mm and (b) 4 mm in the direction substantially perpendicular to the touch screen.

3. The display device according to claim 1, further comprising a control configured to trigger the actuator to move the touch screen in the direction substantially perpendicular to the touch screen to confirm a command input by the touch screen.

4. The display device according to claim 3, wherein the touch screen is movable for a duration one of (a) between 50 ms and 800 ms and (b) between 100 ms and 400 ms in the direction substantially perpendicular to the touch screen to confirm the command input.

5. The display device according to claim 3, wherein the touch screen is movable periodically in the direction substantially perpendicular to the touch screen to confirm the command input.

6. The display device according to claim 5, wherein the touch screen is movable for a duration one of (a) between 50 ms and 800 ms and (b) 100 ms and 400 ms in the direction substantially perpendicular to the touch screen to confirm the command input.

7. The display device according to claim 3 wherein the touch screen is movable periodically with a frequency between 10 and 80 Hz in the direction substantially perpendicular to the touch screen to confirm the command input.

8. The display device according to claim 7, wherein the touch screen is movable for a duration one of (a) between 50 ms and 800 ms and (b) between 100 ms and 400 ms in the direction substantially perpendicular to the touch screen to confirm the command input.

9. The display device according to claim 3, wherein the touch screen is movable with a decaying oscillation in the direction substantially perpendicular to the touch screen to confirm the command input.

10. The display device according to claim 9, wherein the decaying oscillation includes an envelope curve with an exponential component.

11. The display device according to claim 10, wherein the touch screen is movable periodically with a frequency between 10 and 80 Hz in the direction substantially perpendicular to the touch screen to confirm the command input.

12. The display device according to claim 11, wherein the touch screen is movable for a duration one of (a) between 50 ms and 800 ms and (b) between 100 ms and 400 ms in the direction substantially perpendicular to the touch screen to confirm the command input.

13. The display device according to claim 1, further comprising a control configured to trigger the actuator to move the touch screen in the direction substantially perpendicular to the touch screen when a user of the touch screen touches the touch screen at a spot displayable by the touch screen.

14. The display device according to claim 13, wherein the spot displayable by the touch screen includes at least one of (a) an operating element depicted on the touch screen, (b) a pushbutton represented on the touch screen, (c) a road represented on the touch screen, (d) a settlement represented on the touch screen and (e) place information represented on the touch screen.

15. The display device according to claim 1, wherein the actuator includes a coil.

16. A display device, comprising:
a touch screen configured to visually display information and to input commands;
an actuator configured to move the touch screen by more than 2 mm in a direction substantially perpendicular to the touch screen; and
a control configured to trigger the actuator to move the touch screen in the direction substantially perpendicular to the touch screen to confirm a command input by the touch screen;
wherein the display device is in a motor vehicle; and
wherein the touch screen and the actuator are configured for use during driving operation of the motor vehicle, and the touch screen is movable by the actuator by more than 2 mm such that movement of the touch screen is detectable by a vehicle occupant during the driving operation of the motor vehicle.

17. The display device according to claim 16, wherein the actuator is configured to move the touch screen by more than one of (a) 3 mm and 4 mm in the direction substantially perpendicular to the touch screen.

18. The display device according to claim 16, wherein the touch screen is movable for a duration one of (a) between 50 ms and 800 ms and (b) between 100 ms and 400 ms in the direction substantially perpendicular to the touch screen to confirm the command input.

19. The display device according to claim 16, wherein the touch screen is movable periodically in the direction substantially perpendicular to the touch screen to confirm the command input.

20. The display device according to claim 19, wherein the touch screen is movable for a duration one of (a) between 50 ms and 800 ms and (b) between 100 ms and 400 ms in the direction substantially perpendicular to the touch screen to confirm the command input.

21. The display device according to claim 16, wherein the touch screen is movable periodically with a frequency between 10 and 80 Hz in the direction substantially perpendicular to the touch screen to confirm the command input.

22. The display device according to claim 21, wherein the touch screen is movable for a duration one of (a) between 50 ms and 800 ms and (b) between 100 ms and 400 ms in the direction substantially perpendicular to the touch screen to confirm the command input.

23. The display device according to claim 16, wherein the touch screen is movable with a decaying oscillation in the direction substantially perpendicular to the touch screen to confirm the command input.

24. The display device according to claim 23, wherein the decaying oscillation includes an envelope curve with an exponential component.

25. The display device according to claim 24, wherein the touch screen is movable periodically with a frequency between 10 and 80 Hz in the direction substantially perpendicular to the touch screen to confirm the command input.

26. The display device according to claim 25, wherein the touch screen is movable for a duration one of (a) between 50 ms and 800 ms and (b) between 100 ms and 400 ms in the direction substantially perpendicular to the touch screen to confirm the command input.

27. The display device according to claim 16, wherein the control is configured to control the actuator to move the touch screen in the direction substantially perpendicular to the touch screen when a user of the touch screen touches the touch screen at a spot displayable by the touch screen.

28. The display device according to claim 27, wherein the spot displayable by the touch screen includes at least one of (a) an operating element represented on the touch screen, (b) a pushbutton represented on the touch screen, (c) a road represented on the touch screen, (d) a settlement represented on the touch screen and (e) place information represented on the touch screen.

29. A navigation system, comprising:
a touch screen configured to visually display at least one of (a) a geographical map and (b) a road map and to detect a touch of the touch screen by a user of the navigation system; and
an actuator configured to move the touch screen as a function of a position of the touch of the touch screen by the user;
wherein the navigation system is in a motor vehicle; and
wherein the touch screen and the actuator are configured for use during driving operation of the motor vehicle, and the touch screen is movable by the actuator by more than 2 mm such that movement of the touch screen is detectable by the user during the driving operation of the motor vehicle.

30. The navigation system according to claim 29, wherein the touch screen is configured to display at least one of (a) a road, (b) a settlement and (c) place information, the at least one of (a) the road, (b) the settlement and (c) the place information, in response to a touch by the user, recognizable to touch of the user by a movement of the touch screen.

31. A method for operating a touch screen for visual display of information and for input of commands, comprising:
moving the touch screen by more than 2 mm in a direction substantially perpendicular to the touch screen;
wherein the touch screen is in a motor vehicle; and
wherein the touch screen is configured for use during driving operation of the motor vehicle, and the touch screen is movable by more than 2 mm such that movement of the touch screen is detectable by a vehicle occupant during the driving operation of the motor vehicle.

32. The method according to claim 31, wherein the touch screen is moved in the moving step by more than one of (a) 3 mm and (b) 4 mm in the direction substantially perpendicular to the touch screen.

33. The method according to claim 31, wherein the touch screen is moved for a duration one of (a) between 50 ms and 800 ms and (b) between 100 ms and 400 ms in the direction substantially perpendicular to the touch screen to confirm command input by the touch screen.

34. The method according to claim 31, wherein the touch screen is moved in the moving step periodically in the direction substantially perpendicular to the touch screen to confirm command input by the touch screen.

35. The method according to claim 31, wherein the touch screen is moved in the moving step periodically with a frequency between 10 and 80 Hz in the direction substantially perpendicular to the touch screen to confirm command input by the touch screen.

36. The method according to claim 31, wherein the touch screen is moved in the moving step with a decaying oscillation in the direction substantially perpendicular to the touch screen to confirm command input by the touch screen.

37. The method according to claim 36, wherein the touch screen is moved in the moving step periodically with a frequency between 10 and 80 Hz in the direction substantially perpendicular to the touch screen to confirm the command input.

38. The method according to claim 31, wherein the touch screen is moved in the moving step in the direction substantially perpendicular to the touch screen when a user of the touch screen touches the touch screen at a spot displayable by the touch screen.

39. A method for operating a touch screen for visual display of information and for input of commands, method comprising:
moving the touch screen by more than 2 mm in a direction substantially perpendicular to the touch screen to confirm a command input by the touch screen;
wherein the touch screen is in a motor vehicle; and
wherein the touch screen is configured for use during driving operation of the motor vehicle, and the touch screen is movable by more than 2 mm such that movement of the touch screen is detectable by a vehicle occupant during the driving operation of the motor vehicle.

40. The method according to claim 39, wherein the touch screen is moved in the moving step by more than one of (a) 3 mm and (b) 4 mm in the direction substantially perpendicular to the touch screen.

41. The method according to claim 39, wherein the touch screen is moved in the moving step for a duration one of (a) between 50 ms and 800 ms and (b) between 100 ms and 400 ms in the direction substantially perpendicular to the touch screen to confirm the command input.

42. The method according to claim 39, wherein the touch screen is moved in the moving step periodically in the direction substantially perpendicular to the touch screen to confirm the command input.

43. The method according to claim 39, wherein the touch screen is moved in the moving step periodically with a frequency between 10 and 80 Hz in the direction substantially perpendicular to the touch screen to confirm the command input.

44. The method according to claim 39, wherein the touch screen is moved in the moving step with a decaying oscillation in the direction substantially perpendicular to the touch screen to confirm the command input.

45. The method according to claim 39, wherein the touch screen is moved in the moving step in the direction substantially perpendicular to the touch screen when a user of the touch screen touches the touch screen at a spot displayable by the touch screen.

46. A method for operating a navigation system including a touch screen for visual display of at least one of (a) a geographical map and (b) a road map, comprising:
detecting a touch of the touch screen by a user of the navigation system at a position highlighted for emphasis on the touch screen; and
moving the touch screen in a direction substantially perpendicular to the touch screen;
wherein the navigation system is in a motor vehicle; and
wherein the touch screen is configured for use during driving operation of the motor vehicle, and the touch screen is movable by more than 2 mm such that movement of the touch screen is detectable by the user during the driving operation of the motor vehicle.
